(19) United States
(12) Patent Application Publication
(10) Pub. No.: US 2011/0087775 A1
(43) Pub. Date: Apr. 14, 2011

(54) PEER-TO-PEER CONTROL DEVICE AND TRANSMISSION OVERLAY MANAGEMENT METHOD

(75) Inventors: Seung-Ik LEE, Daejeon (KR); Jong Hwa Yi, Daejeon (KR); Sung Hei Kim, Daejeon (KR); Wook Hyun, Daejeon (KR); Shin Gak Kang, Daejeon (KR)

(73) Assignee: Electronics and Telecommunications Research, Daejeon (KR)

(21) Appl. No.: 12/902,502

(22) Filed: Oct. 12, 2010

(30) Foreign Application Priority Data
Oct. 12, 2009 (KR) 10-2009-0096766
Oct. 12, 2010 (KR) 10-2010-0099199

(51) Int. Cl. G06F 15/173; G06F 15/16

(52) U.S. Cl. 709/224; 709/227

(57) ABSTRACT

A peer-to-peer (P2P) control device receives peer registration requests from a plurality of peers which want to receive contents and registers information regarding the plurality of peers, and receives an application service and contents registration request from at least one contents server providing contents and registers the information regarding the application service and contents. When the P2P control device receives a request for generating an overlay of desired contents from a requesting peer, it generates a P2P overlay, a logical path along which contents are to be transmitted to the requesting peer, by using the registered information regarding the plurality of peers, information regarding a network to which the plurality of peers are connected, and information regarding the application service corresponding to the desired contents, and delivers the connection information to the requesting peer with reference to the P2P overlay.

### CROSS-REFERENCE TO RELATED APPLICATION

This application claims priority to and the benefit of Korean Patent Application No. 10-2009-0096766 and 10-2010-0099199 filed in the Korean Intellectual Property Office on Oct. 12, 2009 and Oct. 12, 2010, the entire contents of which are incorporated herein by reference.

### BACKGROUND OF THE INVENTION

(a) Field of the Invention

The present invention relates to a peer-to-peer (P2P) control device and method for managing a transmission overlay.

(b) Description of the Related Art

A P2P technique has the characteristics that peers are connected to share resources (e.g., contents computing power, etc.) and all the participating peers serve as servers and clients.

When peers existing on a physical network register for a P2P service, a virtual network, namely, a P2P overlay network, is established among the peers which have registered for the P2P service on the physical network.

The peers in the P2P overlay network generate a virtual logical transmission path (referred to as a “P2P overlay”, hereinafter,) so as to be connected by the P2P overlay to directly share and exchange contents with other peers without any help from a base network such as a server, or the like.

In this case, a logical contents transmission is performed by the P2P overlay, while an actual contents transmission is made through the base network reflecting the P2P overlay. For example, in a P2P overlay including P1 and P2, an actual contents transmission from P1 to P2 is made through P1, an access network to which P1 belongs, a core network, an access network to which P2 belongs, and P2.

In this case, however, peers cannot know about information (e.g., a bandwidth, a transmission delay, a topology, etc.) regarding the base network, generating ineffective P2P overlay that does not reflect information regarding the base network.

In addition, the peers constituting the P2P overlay may be positioned in different types of terminals in different networks, and thus, the peers constituting the P2P overlay may have different transmission and reception performance and characteristics. However, the peers constituting the P2P overlay lacks the ability of detecting the transmission and reception performance and characteristics of the other peers, so they cannot actively reflect the transmission and reception performance and characteristics of the other peers for a P2P overlay generation.

The because the peers generate the P2P overlay without considering the information of the base network and the states of other peers, transmission quality of actual contents is likely to be degraded depending on the states of the base network and the peers.

In addition, a peer may be withdrawn while the overall session is ongoing, and a new peer may participate in the session. In particular, when a peer is withdrawn midway, sub-peers, which receive contents from the corresponding peer, suffers data losses due to a broken connection. Thus, the P2P overlay needs to be actively updated over the participation of the new peer and the withdrawal of the existing peer in order to reduce the data losses.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a peer-to-peer (P2P) control device and method for controlling a transmission overlay having advantages of increasing contents transmission quality by stably and effectively generating a P2P overlay.

An exemplary embodiment of the present invention provides a peer-to-peer (P2P) control device may include a peer registration unit and an overlay generation unit. The peer registration unit may receive peer registration requests from a plurality of peers which want to receive contents, and register information regarding the plurality of peers. The overlay generation unit may receive an overlay generation request of desired contents from a requesting peer among the plurality of peers, generate a P2P overlay by using the information regarding the plurality of peers and information regarding networks to which the plurality of peers are connected, and provide information regarding a connection according to which the desired contents can be received to the requesting peer with reference to the P2P overlay.

Another embodiment of the present invention provides a method for controlling a peer-to-peer (P2P) overlay for a logical transmission of contents by a P2P control device. The method for controlling a transmission overlay may include: receiving peer registration requests from a plurality of peers which want to receive contents and acquiring peer information regarding the plurality of peers; receiving an overlay generation request including a contents identifier of desired contents from a requesting peer among the plurality of peers; generating the P2P overlay by using the peer information regarding the plurality of peers and network information regarding networks to which the plurality of peers are connected; and transmitting connection information of a counterpart to be connected to at least one target participating in the P2P overlay with reference to the P2P overlay.

Yet another embodiment of the present invention provides a method for controlling a peer-to-peer (P2P) overlay for a logical transmission of contents by a peer. The method for controlling a transmission overlay may include: transmitting information regarding the peer to a peer-to-peer (P2P) control device in order to register the information regarding the peer to the P2P control device; transmitting an overlay generation request including a contents identifier of desired contents to the P2P control device; receiving connection information regarding a P2P overlay from the P2P control device; and connecting the P2P overlay with reference to the connection information to receive the contents.

### BRIEF DESCRIPTION OF THE DRAWINGS

FIGS. 1 and 2 are views each illustrating a peer-to-peer (P2P) network system according to an exemplary embodiment of the present invention;

FIG. 3 is a schematic block diagram of a P2P control device illustrated in FIG. 1;

FIG. 4 is a signal flow chart illustrating a service registration process of the P2P control device according to an exemplary embodiment of the present invention;

FIG. 5 is a signal flow chart illustrating a contents registration process of the P2P control device according to an exemplary embodiment of the present invention;

FIG. 6 is a signal flow chart illustrating a contents searching process of the P2P control device according to an exemplary embodiment of the present invention;

FIG. 7 is a signal flow chart illustrating a peer registration process of the P2P control device according to an exemplary embodiment of the present invention;

FIG. 8 is a signal flow chart illustrating a P2P overlay generation process of the P2P control device according to an exemplary embodiment of the present invention;

FIGS. 9 and 10 are signal flow charts each illustrating a P2P overlay updating process of the P2P control device according to first and second exemplary embodiments of the present invention; and

FIG. 11 is a signal flow chart illustrating the process of a method for measuring traffic by the P2P control device according to an exemplary embodiment of the present invention;

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising”, will be understood to imply the inclusion of stated elements but not the exclusion of any other elements.

A peer-to-peer (P2P) control device and a method for controlling a transmission overlay according to exemplary embodiments of the present invention will now be described in detail with reference to the accompanying drawings.

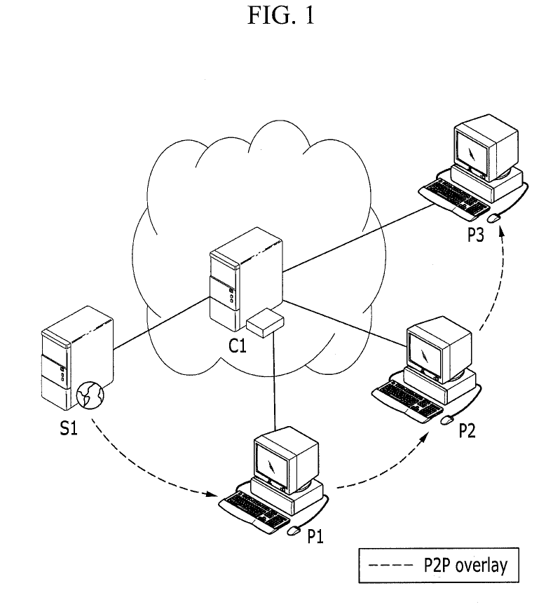

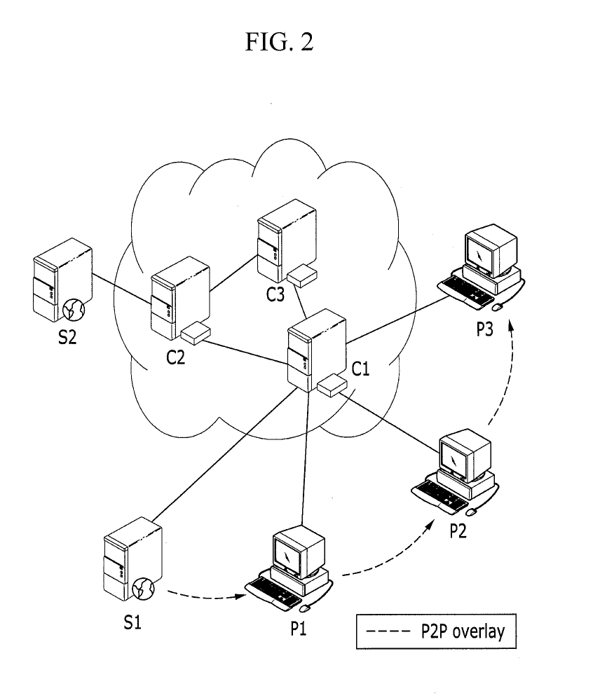

FIGS. 1 and 2 are views each illustrating a peer-to-peer (P2P) network system according to an exemplary embodiment of the present invention.

With reference to FIG. 1, a P2P network system includes a P2P control device C1, a contents server S1, and peers P1 to P3.

FIG. 1 illustrates a P2P network system including one P2P control device C1 and one contents server S1 for the sake of brevity, but, as illustrated in FIG. 2, the P2P network system may include two or more P2P control devices C1 to C3 and contents servers S1 and S2.

According to an application service and contents registration request from the contents server S1, the P2P control device C1 registers and manages an application service and contents, and registers according to a registration request from the peers P1 to P3 and manages the corresponding peers P1 to P3. The P2P control device C1 may deliver the registered information regarding the application service and contents and the registered information regarding the peers P1 to P3 to a different P2P control device (not shown) so that the registered application service and contents and the registered information regarding the peers P1 to P3 can be distributedly managed.

In addition, the P2P control device C1 performs management such as generating, maintaining, and updating a P2P overlay in order to deliver contents by using the information regarding the application service, the information regarding the contents, the information regarding the peers P1 to P3, and information regarding a network to which the peers P1 to P3 are connected. Here, the P2P overlay refers to a logical transmission path configured among the peers participating in the application service and a session, and an actual contents transmission is made via a base network reflecting the P2P overlay.

The P2P control device C1 may be strategically deployed by a network service provider or a third party service provider.

The contents server S1 provides contents regarding an application service. The contents server S1 is positioned at the uppermost portion of the P2P overlay, and when a lower peer (e.g., P1) of the P2P overlay requests contents, the contents server S1 transmits contents through the P2P overlay.

When the contents server S1 is ready for an application service and contents regarding the application service, the contents server S1 registers the application service and contents to the P2P control device C1. The contents providing a desired service may include different types of contents and a different version of contents of the same type. The contents may be stored in the contents server S1, and a portion of the contents may be stored in the contents server S1 and the other remaining portion of the contents may be stored in a different contents server (S2 in FIG. 2).

As shown in FIG. 2, when two or more P2P control devices C1 to C3 exist in the P2P network system, the contents server S1 may select the P2P control device C1 to which the application service and contents are to be registered. For example, the contents server S1 may select the P2P control device C1 physically located in proximity as a P2P control device to which the application service and the contents are to be registered. Information regarding the registered application service and contents may be used to generate, maintain, and update a P2P overlay.

The peers P1 to P3 receive contents for the application service and, at the same time, relays and transmits the received contents to a lower peer on the P2P overlay.

Before requesting a service from the P2P control device C1, the peers P1 to P3 request a registration from the P2P control device C1 and then registers themselves to the P2P control device C1. In this case, as shown in FIG. 2, when two or more P2P control devices C1 to C3 exist in the P2P network system, the peers P1 to P3 may select the P2P control device C1 to which they are to be registered. For example, the peers P1 to P3 may select the P2P control device C1 located physically in proximity as a P2P control device to which they are to be registered.

Also, the peers P1 to P3 may request a P2P overlay with respect to a desired service from the P2P control device C1.

For example, when the peer P3 selects the type of contents providing a desired service, the P2P control device C1 selects a version of contents fitting the characteristics of the peer P3 with respect to the corresponding type of contents which has been selected by the peer P3, and selects the contents server S1 for providing the corresponding version of the contents.

When the contents server S1 is selected, the P2P control device C1 generates a P2P overlay between the contents server S1 and the peer P3 in consideration of the information regarding the application service, information regarding the contents, the information regarding the peers P1 to P3, and information regarding the network, and provides connection information corresponding to the P2P overlay to the contents server S1 and the peers P1 to P3 participating in the P2P overlay.

The contents server S1 transfers the corresponding type of contents to a lower peer on the basis of the connection information corresponding to the P2P overlay. This contents are eventually transferred to the peer P1. In this case, the contents server S1 is a parent node on the P2P overlay. One or more parent nodes may be provided according to a P2P overlay generation algorithm and may have a lower node, namely, a child node, from the beginning.

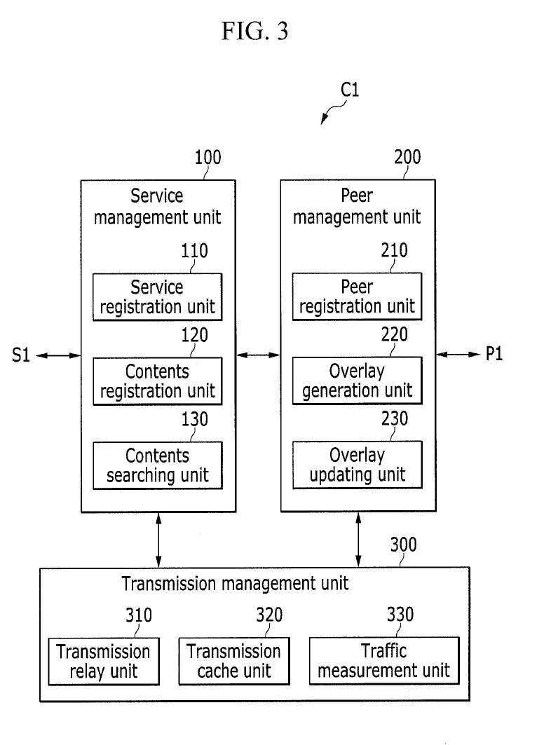

FIG. 3 is a schematic block diagram of the P2P control device illustrated in FIG. 1.

With reference to FIG. 3, the P2P control device C1 includes a service management unit 100, a peer management unit 200, and a transmission management unit 300.

The service management unit 100 includes a service registration unit 110, a contents registration unit 120, and a contents searching unit 130.

The peer management unit 200 includes a peer registration unit 210, an overlay generation unit 220, and an overlay updating unit 230.

The transmission management unit 300 includes a transmission relay unit 310, a transmission cache unit 320, and a traffic measurement unit 330.

In the service management unit 100, the service registration unit 110 receives an application service registration request from the contents server S1 and registers information regarding the application service. In this case, the service registration unit 110 may selectively receive service level agreement (SLA) information from the contents server S1. The SLA information may include a maximum bandwidth, a minimum end-to-end delay, the number of maximum concurrent users, the presence and absence of a transmission relay function, the presence and absence of a transmission cache function, and the like.

The contents registration unit 120 receives a contents registration request from the contents server S1 and registers information regarding contents providing an application service.

The contents searching unit 130 searches for an appropriate version of contents fitting the characteristics of the peer P1 with respect to a corresponding type of contents selected by the peer P1, and transfers the information regarding the searched version of contents to the peer P1. Also, the contents searching unit 130 selects the contents server S1 for providing the corresponding version of contents.

In the peer management unit 200, the peer registration unit 210 registers the peer P1 according to a registration request from the peer P1, and manages information regarding the registered peer P1. The information regarding the peer P1 may include a network connection type, hardware information, terminal performance, network transmission, reception capabilities and bandwidth. The information regarding the peer P1 may be used to generate or update a P2P overlay.

The overlay generation unit 220 may generate a P2P overlay according to a request from the peer P1, and transfers information regarding a connection to parent and child nodes corresponding to the P2P overlay to the peer P1. In this case, the overlay generation unit 220 generates the P2P overlay by collectively analyzing and considering information regarding the corresponding application service, the peer, and the network. The information regarding the network may include a network topology, a maximum bandwidth, a current network usage, a transmission delay time, and the like, and the overlay generation unit 220 may acquire these types of network information through various methods. Also, the information regarding the application service and the peer may be acquired in the process of registering the application service and the peer.

The overlay updating unit 230 monitors a state of peers participating in the P2P overlay and the state of the network to which the peer is connected, and determines whether to change the P2P overlay. In detail, the overlay updating unit 230 periodically checks the states of the peers participating in the P2P overlay, and if there is a peer which has been abnormally terminated or does not properly exhibit its performance, the overlay updating unit 230 may change the P2P overlay to which the corresponding peer belongs. In addition, the overlay updating unit 230 may monitor the state and performance of the network to which the peers participating in the P2P overlay are connected, and when the state and performance of the network fall short of the performance qualification (or performance conditions) of the overall P2P overlay, the overlay updating unit 230 may change the corresponding P2P overlay.

In the transmission management unit 300, the transmission relay unit 310 selectively participates in the P2P overlay to relay transmission of the contents to a lower node. Namely, the P2P control device C1 can participate in the P2P overlay to configure the P2P overlay according to the function of the transmission relay unit 310.

This provides the effect of improving the performance of the P2P overlay by making the P2P control device C1 participate in the P2P overlay to configure a detour overlay when the performance of the P2P overlay is degraded due to the factors such as a network congestion, an interruption, the absence of a relay peer, and the like.

Also, the transmission relay unit 310 may provide a peer-to-peer connection relay function on the P2P overlay in order to allow for a connection to a peer located behind a firewall installed for the purpose of using a security and network address translation (NAT).

In order to reduce the burden of the contents server S1 on the P2P overlay or a peer transferring contents, the transmission cache unit 320 may cache corresponding contents and transfers the same to a different peer. Namely, the P2P control device C1 may selectively participate in the P2P overlay to cache received contents and transfer the same to a different peer according to the function of the transmission cache unit 320.

The transmission relay unit 310 and the transmission cache unit 320 may be selectively implemented in the P2P control device C1.

The traffic measurement unit 330 is periodically apprised of the amount of transmission and reception traffic by the peers of the P2P overlay, and stores and manages the same. The amount of transmission and reception traffic may be used to improve the P2P overlay, or the like, through a peer incentive, charging (or billing), or peer performance state monitoring.

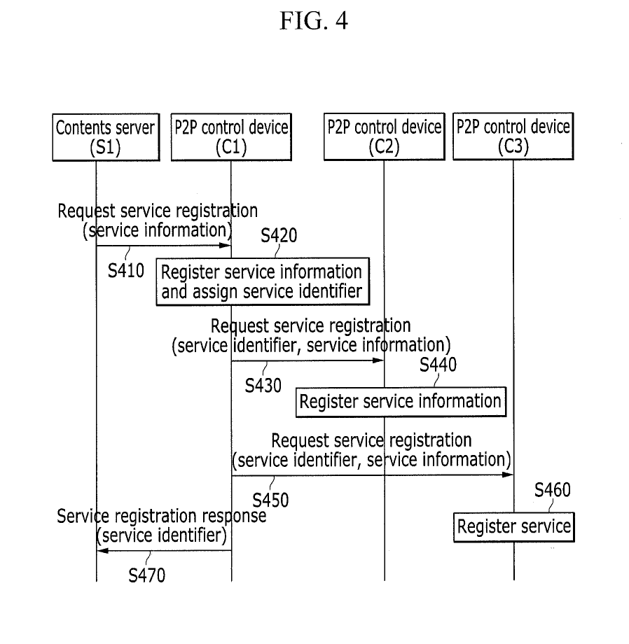

The operation of the P2P control device according to an exemplary embodiment of the present invention will now be described in detail with reference to FIGS. 4 to 11. The description will be made on the basis of the P2P control device C1 in the P2P network system of FIG. 2.

FIG. 4 is a signal flow chart illustrating a service registration process of the P2P control device according to an exemplary embodiment of the present invention.

With reference to FIGS. 2 and 4, when the contents server S1 is ready to start an application service, it requests a service registration from the P2P control device C1 while transferring information regarding a service (S410).

The P2P control device C1 registers information regarding the service transferred from the contents server S1, and manages the registered information regarding the service by assigning a service identifier thereto.

In addition, the P2P control device C1 may transfer the service identifier and the information regarding the service to the other P2P control devices C2 and C3 so that the information regarding the service can be distributedly managed (S430, S450).

Upon receiving the service identifier and the information regarding the service from the P2P control device C1, the P2P control devices C2 and C3 register the information regarding the service corresponding to the service identifier and manage the same (S440, S460).

When the service registration is completed, the P2P control device C1 transmits a service registration response with respect to the service registration request, while transferring the service identifier to the contents server S1 (S470).

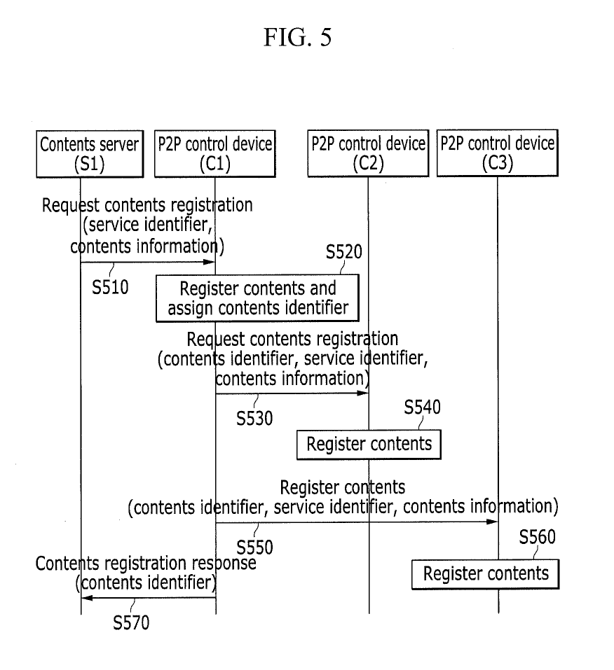

FIG. 5 is a signal flow chart illustrating a contents registration process of the P2P control device according to an exemplary embodiment of the present invention.

With reference to FIGS. 2 and 5, when the contents server S1 is ready to transmit contents which can provide a corresponding application service, it requests a contents registration, while transferring a service identifier and contents information to the P2P control device C1 (S510).

The P2P control device C1 registers the contents information received from the contents server S1 and manages the contents information by assigning a contents identifier to the registered contents information (S520).

In addition, the P2P control device C1 may transfer the contents identifier, the service identifier, and contents information to the other P2P control devices C2 and C3 so that the information regarding the contents can be distributedly managed (S530, S550).

Upon receiving the contents identifier, the service identifier, and contents information from the P2P control device C1, the P2P control devices C2 and C3 register the contents information to the corresponding service identifier and manages the contents information by discriminating it by the contents identifier (S540, S560).

When the contents registration is completed, the P2P control device C1 transmits a contents registration response with respect to the contents registration request, while transferring the contents identifier to the contents server S1 (S570).

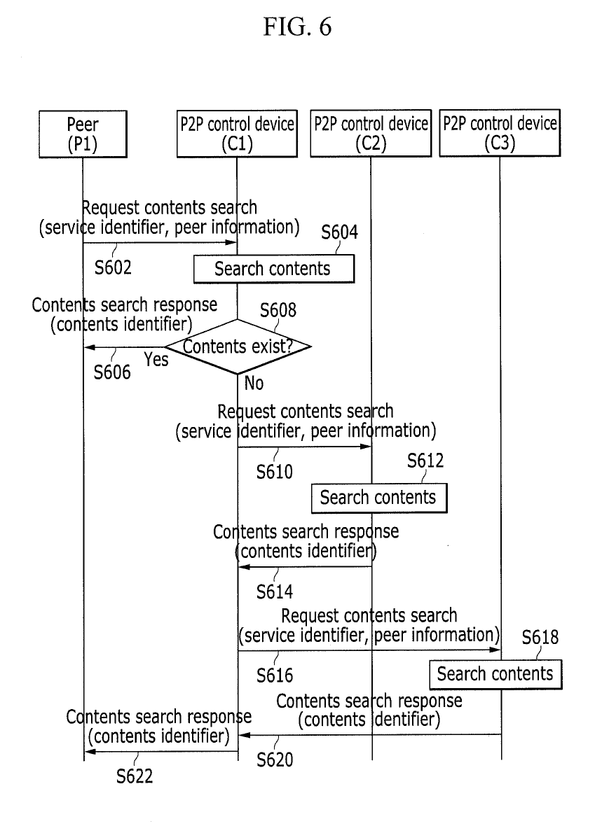

FIG. 6 is a signal flow chart illustrating a contents searching process of the P2P control device according to an exemplary embodiment of the present invention.

With reference to FIGS. 2 and 6, the peer P1 requests the P2P control device C1 to search for contents, while transferring information regarding a desired service and its own information (S602).

The P2P control device C1 searches for an appropriate version of contents fitting the characteristics of the peer P1 on the basis of the service information and peer information (S604), and transmits a contents search response with respect to the contents search request, while transferring a contents identifier corresponding to the searched contents to the peer P1 (S606). In this case, when the P2P control device C1 fails to search a contents list, managed by the P2P control device C1, for the version of contents suitable for the characteristics of the peer P1 (S608), it may request the other P2P control devices C2 and C3 to search for contents.

Namely, the P2P control device C1 requests the P2P control devices C2 and C3 to search for contents, while transferring service information and peer information to the P2P control devices C2 and C3 (S610, S616).

Upon receiving the request for searching for contents from the P2P control device C1, the P2P control devices C2 and C3 search for contents on the basis of the service information and the peer information, respectively (S612, S618), and transmits a contents search response with respect to the contents search request, while transferring a contents identifier corresponding to searched contents to the P2P control device C1 (S614, S620).

The P2P control device C1 transmits the contents search response with respect to the contents search request, while transferring one of contents identifiers transferred from the P2P control devices C2 and C3 to the peer P1 (S622).

For example, the P2P control device C1 may first request the P2P control device C2 to search for contents. In this case, if the P2P control device C1 receives a response indicating that a version of contents suitable for the characteristics of the peer P1 from the P2P control device C2, the P2P control device C1 may then request for the P2P control device C3 to search for contents.

For another example, the P2P control device C1 may simultaneously request the P2P control devices C2 and C3 to search for contents and provide a contents identifier of a contents search response, which has been first received from among the P2P control devices C2 and C3, to the peer P2.

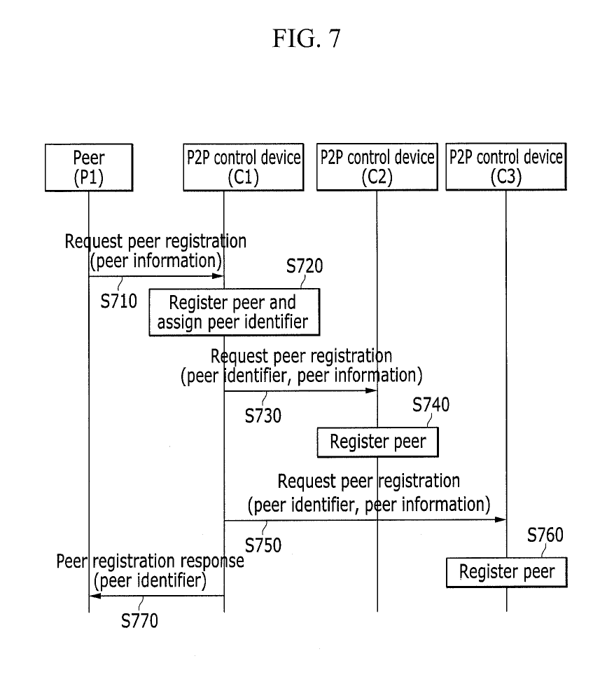

FIG. 7 is a signal flow chart illustrating a peer registration process of the P2P control device according to an exemplary embodiment of the present invention.

With reference to FIG. 7, the peer P1 may request a peer registration from the P2P control device C1, while transferring its own information to the P2P control device C1, before requesting an application service (S710).

The P2P control device C1 registers peer information, and assigns a peer identifier to the registered peer information and manages the same (S720).

In addition, the P2P control device C1 may transfer the registered peer information and the peer identifier to the other P2P control devices C2 and C3 so that the peer information can be distributedly managed (S730, S750).

Upon receiving the peer information and the peer identifier from the P2P control device C1, the P2P control devices C2 and C3 register the peer information to the corresponding peer identifier and manage the same (S740, S760).

When the peer registration is completed, the P2P control device C1 transmits a peer registration response with respect to the peer registration request, while transferring the registered peer identifier to the peer P1 (S770).

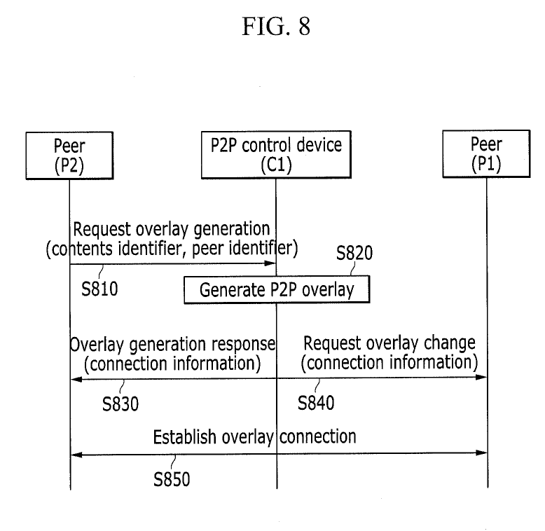

FIG. 8 is a signal flow chart illustrating a P2P overlay generation process of the P2P control device according to an exemplary embodiment of the present invention.

With reference to FIG. 8, the peer P2 requests the P2P control device Cl to generate an overlay, while transferring its contents identifier and peer identifier to the P2P control device C1, in order to receive contents (S810).

The P2P control device C1 generates a P2P overlay by using service information corresponding to the contents identifier and registered peer information and network information (S820).

Thereafter, the P2P control device C1 transmits an overlay generation response with respect to the overlay generation request, while transferring the information regarding the peer P1, for which the peer P2 is to establish an overlay connection, namely, connection information, to the peer P2 (S830).

In addition, the P2P control device C1 requests even the peer P1, for which the peer P2 is to establish an overlay connection, to change an overlay, while transferring the information regarding the peer P2, namely, the connection information and the contents identifier, to the peer P1 (S840).

The peers P1 and P2 establish an overlay connection on the basis of the connection information received from the P2P control device C1. Then, the peer P2 is able to receive contents via the peer P1 (S850).

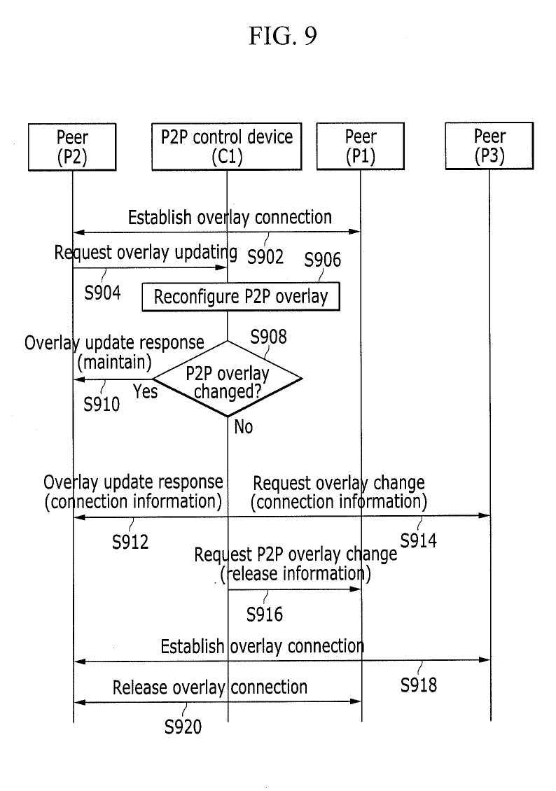

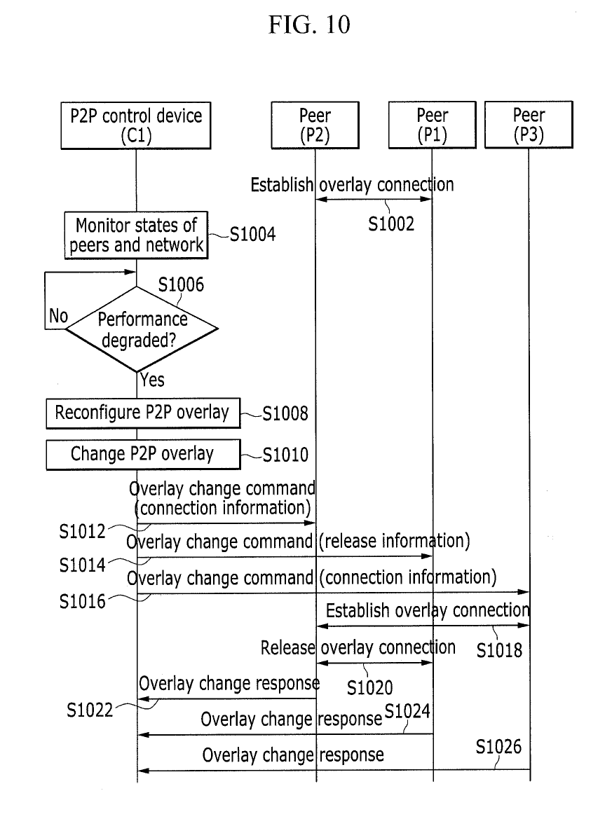

FIGS. 9 and 10 are signal flow charts each illustrating a P2P overlay updating process of the P2P control device according to first and second exemplary embodiments of the present invention.

First, with reference to FIG. 9, in a state in which an overlay connection is established between the peers P1 and P2 (S902), the peer P2 may request overlay updating from the P2P control device C1, while transmitting a contents identifier and its peer identifier to the P2P control device C1 (S904).

Upon receiving the overlay updating request, the P2P control device C1 reconfigures the P2P overlay by using service information, peer information, and network information (S906). In this case, the P2P overlay reconfigured according to the service information, the peer information, and the network information may be the same as or different from that of a previous P2P overlay.

When the reconfigured P2P overlay is the same as a previous one, the P2P overlay may only need to be maintained, so the P2P control device C1 transmits an overlay update response with respect to the overlay update request, while transferring the information regarding the peer P1 (S908, S910).

Meanwhile, when the P2P overlay is different from a previous one, the P2P overlay must be changed. When the P2P overlay is to be changed, the P2P control device C1 transmits an overlay update response with respect to the overlay update request, while transferring information regarding the peer P3, for which the peer P2 is to establish an overlay connection, to the peer P2 (S908, S912).

Also, the P2P control device C1 requests the peer P3, for which the peer P2 is to establish a new overlay connection, to change the overlay, while transferring the information regarding the peer P2 and the contents identifier to the peer P3 (S914), and requests the peer P1, which has been previously established for an overlay connection with the peer P2, to change the overlay, while transferring the information regarding the peer P2, namely, release information and the contents identifier to the peer P1(S916).

The peers P1 and P3 establish an overlay connection on the basis of the connection information received from the P2P control device C1 (S918), and at the same time, the peers P1 and P2 release the overlay connection on the basis of the connection information received from the P2P control device C1 (S920). Then, the peer P2 can receive contents via the peer P3.

The peer P2 may request the P2P control device C1 to periodically perform overlay updating, while transferring the contents identifier and its peer identifier to the P2P control device C1 Through this process, the P2P overlay can be periodically updated, and thus, the performance of the P2P overlay can be continuously improved.

The P2P control device C1 may update the P2P overlay upon periodically receiving the request for the overlay updating from the peer P2 or may update the P2P overlay by monitoring the states of peers and the network.

With reference to FIG. 10, in a state in which an overlay connection is established between the peers P1 and P2 (S1002), the P2P control device C1 monitors the registered peers and the network (S1004).

Monitoring the states of the peers and the network, the P2P control device C1 determines whether or not the performance of the P2P overlay is degraded (S1006). For example, the P2P control device C1 may determine that the P2P overlay is degraded when the network is congested or interrupted or when a relay peer does not exist. In addition, the P2P control device C1 may determine that the performance of the P2P overlay is degraded when the performance qualification of the P2P overlay falls short of pre-set qualification (or pre-set conditions).

When the performance of the P2P overlay is degraded, the P2P control device C1 reconfigures the P2P overlay by using service information, peer information, and network information (S1008), and changes the corresponding P2P overlay (S1010).

The P2P control device C1 commands the peers P1, P2, and P3 involved in the change of the P2P overlay to change the P2P overlay, while transferring a contents identifier and connection (or release) information to the peers P1, P2, and P3 (S1012, S1014, S1016).

The peers P1 and P2 establish an overlay connection on the basis of the connection information received from the P2P control device C1 (S1018), and at the same time, the peers P1 and P2 release the overlay connection on the basis of the connection information received from the P2P control device C1 (S1020).

When the establishment of the overlay connection or the connection release is completed, the peers P1, P2, and P3 transmit an overlay change response with respect to the overlay change command to the P2P control device C1 (S1022, S1024, S1026).

In this manner, the P2P control device C1 can actively change the P2P overlay by continuously monitoring the states of the peers and the network, so a loss of contents possibly caused by an interruption of the P2P overlay can be prevented, and resultantly, the performance of the P2P overlay can be improved.

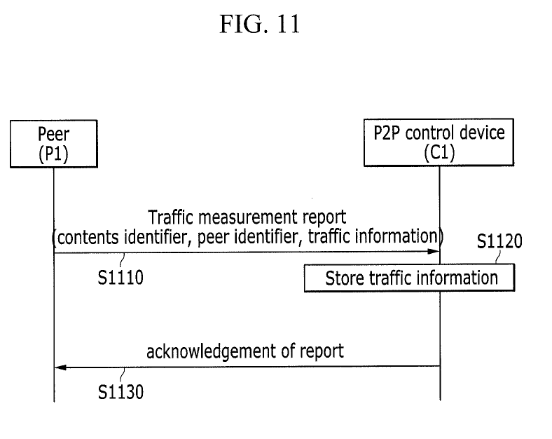

FIG. 11 is a signal flow chart illustrating the process of a method for measuring traffic by the P2P control device according to an exemplary embodiment of the present invention.

With reference to FIG. 11, the peer P1 measures traffic according to a contents transmission, and reports traffic information to the P2P control device C1, while transferring a contents identifier, its peer identifier, and traffic information to the P2P control device C1 (S1110).

The P2P control device C1 stores the traffic information, apprised by the peer P1, by contents identifier and peer identifier (S1120) and transmits an acknowledgement with respect to the report to the peer P1 (S1130).

The peer P1 may report the traffic information to the P2P control device C1 according to a pre-set traffic report period.

According to exemplary embodiments of the present invention, because a P2P overlay can be generated by collectively reflecting information regarding a service, a peer, and a network, contents can be effectively transmitted, and thus, the user can be provided with a service of improved quality.

In addition, because the state of the peer and the state of the network are actively reflected for a P2P overlay, degradation of performance of the P2P overlay can be minimized, and also, because appropriate contents are searched and selected in consideration of transmission and reception performance and characteristics of peers, equity in quality between peers can be guaranteed.

The exemplary embodiments of the present invention as described so far are not implemented only through a device or a method but may be implemented through a program that can realize a function corresponding to the configuration of the exemplary embodiments of the present invention or a recording medium storing the program, and such implementations may be easily made by a skilled person in the art to which the present invention pertains from the foregoing exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A peer-to-peer (P2P) control device comprising:
a peer registration unit configured to receive peer registration requests from a plurality of peers which want to receive contents, and register information regarding the plurality of peers; and
an overlay generation unit configured to receive an overlay generation request of desired contents from a requesting peer among the plurality of peers, generate a P2P overlay by using the information regarding the plurality of peers and information regarding networks to which the plurality of peers are connected, and provide information regarding a connection according to which the desired contents can be received to the requesting peer with reference to the P2P overlay.

2. The device of claim 1, further comprising:
an overlay updating unit configured to receive a request for updating the P2P overlay from the requesting peer and change the P2P overlay by using the information regarding the plurality of peers and the information regarding the networks.

3. The device of claim 1, further comprising:
an overlay updating unit configured to monitor the state of peers and the state of the networks involved in the P2P overlay, and change the P2P overlay.

4. The device of claim 1, further comprising:
a service registration unit configured to receive information regarding an application service from at least one contents server and register the information regarding the application service; and
a contents registration unit configured to receive information regarding contents for providing the application service from the at least one contents server and register the information regarding the contents,
wherein the overlay generation unit generates the P2P overlay by additionally using the information regarding the application service.

5. The device of claim 1, further comprising:
a contents searching unit configured to receive a request for searching for the desired contents from the requesting peer, search for the contents on the basis of information regarding the requesting peer, and provide a contents identifier of searched contents to the requesting peer,
wherein the overlay generation request comprises the contents identifier.

6. The device of claim 5, wherein the information regarding the peers comprises at least one of a network connection form, hardware information, and transmission and reception capabilities.

7. The device of claim 1, wherein the information regarding the network comprises at least one of a network topology, bandwidth, a network usage, and a transmission delay time.

8. The device of claim 1, further comprising:
a transmission relay unit configured to selectively participate in the P2P overlay to relay a transmission of the contents to a lower peer.

9. The device of claim 1, further comprising:
a transmission cache unit configured to selectively participate in the P2P overlay to cache the contents and transmit the same to a lower peer.

10. The device of claim 1, further comprising:
a traffic measurement unit configured to receive traffic information according to the transmission of the contents and store the same.

11. A method for controlling a peer-to-peer (P2P) overlay for a logical transmission of contents by a P2P control device, the method comprising:
receiving peer registration requests from a plurality of peers which want to receive contents and acquiring peer information regarding the plurality of peers;
receiving an overlay generation request including a contents identifier of desired contents from a requesting peer among the plurality of peers;
generating the P2P overlay by using the peer information regarding the plurality of peers and network information regarding networks to which the plurality of peers are connected; and
transmitting connection information of a counterpart to be configured to be connected to at least one target involved in the P2P overlay with reference to the P2P overlay.

12. The method of claim 11, further comprising:
receiving a service registration request comprising information regarding an application service from at least one contents server providing the contents, and registering the application service, and
the generating of the P2P overlay comprises:
acquiring information regarding an application service corresponding to the contents identifier; and
generating the P2P overlay by using the peer information regarding the plurality of peers, the network information, and the information regarding the applications service.

13. The method of claim 11, further comprising:
receiving a contents registration request including information regarding the contents from the at least one contents server and registering the information regarding the contents; and
transmitting a contents registration response including a contents identifier corresponding to the information regarding the contents to the at least one contents server.

14. The method of claim 13, wherein the receiving of the overlay generation request comprises:
receiving a request for searching for the desired contents from the requesting peer;
searching for a contents identifier of the desired contents by using peer information regarding the requesting peer; and
transferring the contents identifier of the desired contents to the requesting peer.

15. The method of claim 14, wherein the peer information may include at least one of a network connection form, hardware information, and transmission and reception capabilities.

16. The method of claim 11, further comprising:
receiving an overlay update request from the requesting peer; and
changing the P2P overlay by using the peer information regarding the plurality of peers and the network information.

17. The method of claim 11, further comprising:
monitoring the target and a state of a network to which the target has been connected, to determine whether or not the P2P overlay is requested to be changed; and
when the P2P overlay is required to be changed, changing the P2P overlay.

18. A method for controlling a peer-to-peer (P2P) overlay for a logical transmission of contents by a peer, the method comprising:
transmitting information regarding the peer to a peer-to-peer (P2P) control device in order to register the information regarding the peer to the P2P control device;
transmitting an overlay generation request including a contents identifier of desired contents to the P2P control device;
receiving connection information regarding a P2P overlay from the P2P control device; and
connecting the P2P overlay with reference to the connection information to receive the contents.

19. The method of claim 18, wherein the transmitting of the overlay generation request comprises:
requesting the P2P control device to search for the desired contents;
receiving the contents identifier searched by the P2P control device from the P2P control device; and
transmitting the overlay generation request comprising the contents identifier.
wherein the P2P control device searches for the peer information regarding the peer.

20. The method of claim 18, further comprising:
Receiving change information regarding the P2P overlay from the P2P control device; and
changing the P2P overlay with reference to the change information to receive the contents.
